(19) United States
(12) Patent Application Publication
(10) Pub. No.: US 2012/0023521 A1
(43) Pub. Date: Jan. 26, 2012

(54) PROVIDING REGIONAL CONTENT INFORMATION TO A USER DEVICE BY USING CONTENT INFORMATION RECEIVED FROM A CONTENT PROVIDER

(75) Inventors: John Patrick Lordan, Calabasas, CA (US); Walter Richard Klappert, Los Angeles, CA (US)

(73) Assignee: Rovi Technologies Corporation

(21) Appl. No.: 12/843,812

(22) Filed: Jul. 26, 2010

(51) Int. Cl. H04N 7/025; G06F 15/16; H04N 7/16; G06F 3/01

(52) U.S. Cl. 725/35; 715/747; 725/151

(57) ABSTRACT

A method and a system are put forth for providing regional content information to a user device (e.g., television, laptop, cell phone, etc.). In one example, the system provides content information messages that provide explanations of cultural peculiarities that may occur in the original media content (e.g., television programs, Internet streams, etc.). Accordingly, the system allows media content to be understood by various users who have different cultural backgrounds.

### FIELD OF THE INVENTION

The present invention relates to content information for media content (e.g., television programs, Internet streams, etc.). More particularly, the present invention relates to providing regional content information to a user device (e.g., television, laptop, cell phone, etc.).

### BACKGROUND

Media content (e.g., television program, Internet stream, etc.) is frequently distributed globally. It is increasingly difficult for producers of media content to consider how certain media content may not be culturally understandable to some users of the media content. For example, certain references (e.g., jokes, sayings, etc.) in a television program may not make sense to some foreign users. Original media content typically lacks explanations of cultural peculiarities that may exist for some users. A foreign user may feel as if they are on the outside of internal communications that are not intended for the foreign user. Such a feeling may turn an otherwise enjoyable viewing experience into a viewing experience that is not enjoyable.

Media content may be even less culturally understandable when the media content is shared among countries that share the same language but have different cultures (e.g., the United States, the United Kingdom, Australia and most of Canada). In such a case, the media content is often in English or another common language, and no translation is necessary. Because no translation takes place, such television programs do not get the localization benefits that oftentimes come with good language translations.

When a user does not understand a cultural reference in media content, a user may access the Internet and perform a search for information by using a search engine (e.g., Google™, Yahoo!™, etc.). Such a process is inconvenient and time consuming. Others users may opt to continue watching without performing an Internet search in order to watch the media content (e.g., television program) without interruption. Such viewing experiences leave a lot to be desired for a user.

### SUMMARY

Media content (e.g., television program, Internet stream, etc.) may not be culturally understandable to some users due to the broader range of users that receive media content nowadays. Accordingly, it is useful to provide content information to accompany media content in order to make certain media content culturally understandable to some users.

The system is configured for providing content information that is culturally relevant to a particular user. The system predicts a user's culture by using one or more user settings, including without limitation the indicated location of the user device. The system then provides, to the user device, regional content information for making the media content culturally understandable for the user.

In a first embodiment, a method and a system are described for providing content information. Operations of the method and the system comprise the following: receiving one or more user settings that describe preferences for regional content information to be received at a user device, wherein the one or more user settings include at least location data for the user device; receiving, from one or more content providers, media content and content information; determining which content information to provide for display based on the media content and the one or more user settings; and providing for display a content information message that includes regional content information associated with the media content and the one or more user settings, wherein the regional content information is culturally relevant to the location data that is included in the one or more user settings.

In a second embodiment, a computer readable medium comprises one or more instructions for providing content information. The one or more instructions are configured for causing one or more processors to perform the following steps: receiving one or more user settings that describe preferences for regional content information to be received at a user device, wherein the one or more user settings include at least location data for the user device; receiving, from one or more content providers, media content and content information; determining which content information to provide for display based on the media content and the one or more user settings; and providing for display a content information message that includes regional content information associated with the media content and the one or more user settings, wherein the regional content information is culturally relevant to the location data that is included in the one or more user settings.

The invention encompasses other embodiments configured as set forth above and with other features and alternatives. It should be appreciated that these embodiments may be implemented in numerous ways, including as a method, a process, an apparatus, a system and/or a device.

### BRIEF DESCRIPTION OF THE DRAWINGS

The inventive embodiments will be readily understood by the following detailed description in conjunction with the accompanying drawings. To facilitate this description, like reference numerals designate like structural elements.

FIG. 1 shows a user device that displays an example of output of operations of a system, in accordance with some embodiments;

FIG. 2 shows a user device that displays another operation of a system, in accordance with some embodiments;

FIG. 3 is a block diagram of a system configured for providing regional content information to a user system, in accordance with some embodiments;

FIG. 4 is a block diagram of a system configured for providing regional content information to a user system, including a user device having a content information device, in accordance with some embodiments;

FIG. 5 is a block diagram of a system configured for providing regional content information to a user system, including a set-top box having a content information device, in accordance with some embodiments;

FIG. 6 is a block diagram of generalized user system, in accordance with some embodiments;

FIG. 7 is an example of a user device displaying a content information menu, in accordance with some embodiments;

FIG. 8 is an example of a user device displaying a content information menu that includes without limitation controls for user settings, in accordance with some embodiments;

FIG. 9 is an example of a user device displaying a content information menu that includes controls for setting intensity levels for content information messages, in accordance with some embodiments;

FIG. 10 is a diagram of a system configured for providing regional content information to a user system, wherein a content provider is a source of content information, in accordance with some embodiments;

FIG. 11 is a flowchart of a method for providing regional content information to a user system, wherein a content provider is a source of content information, in accordance with some embodiments;

FIG. 12 is a diagram of a system configured for providing regional content information to a user system, wherein a database system is a source of content information, in accordance with some embodiments;

FIG. 13 is a flowchart of a method for providing regional content information to a user system, wherein a database system is a source of content information, in accordance with some embodiments;

FIG. 14 is a diagram of a system configured for providing regional content information to a user system, in accordance with some embodiments;

FIG. 15 is a flowchart of a method for providing regional content information to a user system, in accordance with some embodiments;

FIG. 16 is a flowchart of a method for delivering regional content information to a user system from a content information source, in accordance with some embodiments; and

FIG. 17 is a block diagram of a general and/or special purpose computer system, in accordance with some embodiments.

### DETAILED DESCRIPTION

An invention is disclosed for a method and a system for providing regional content information to a user device (e.g., television, laptop, cell phone, etc.). Numerous specific details are set forth in order to provide a thorough understanding of various embodiments. It will be understood, however, to one skilled in the art, that the embodiments may be practiced with other specific details.

### DEFINITIONS

Some terms are defined below in alphabetical order for easy reference. These terms are not rigidly restricted to these definitions. A term may be further defined by its use in other sections of this description.

“Content information” means information that describes, supplements and/or enhances media content. Content information may include without limitation production information, pop culture trivia, religion facts, history facts, metadata, and annotations that are culturally associated with media content. Media content is defined below.

“Content information source” means an entity configured for providing content information to one or more user devices. Examples of a content information source include without limitation an application server, a web server, a content information delivery device, a database and/or a user device.

“Content provider” means an entity configured for providing media content to one or more user devices. Examples of a content information source include without limitation a cable television provider, a satellite television provider, a television broadcaster, and/or a streaming content provider.

“Database” means a collection of data organized in such a way that a computer program may quickly select desired pieces of the data. A database is an electronic filing system. In some implementations, the term “database” may be used as shorthand for “database management system” and/or “database system”.

“Device” means software, hardware or a combination thereof. A device may sometimes be referred to as an apparatus. Examples of a device include without limitation a television, set-top box, a laptop computer, a cell phone, a display, a database, a server, a computer mouse, a hard disk and a software application such as Microsoft Word™.

“Electronic program guide” (EPG) means a displayed menu of program scheduling information shown by a content provider (e.g., cable provider or satellite TV provider) to its subscribers. An EPG may be distributed by specialized video generation equipment housed within each content provider's central television distribution facility. By using an EPG, users may see a menu that lists programs both currently available as well as scheduled to be available. An EPG provides users of television, radio, and/or other media applications with continuously updated menus displaying scheduling information for current and/or upcoming programming. An interactive form of an EPG is an interactive program guide (IPG). “Interactive program guide” (IPG) means an interactive form of a program guide. An IPG allows television users and radio listeners to navigate scheduling information menus interactively, selecting and discovering programming by time, title, station, and/or genre by using an input device such as a keypad, computer keyboard, or TV remote controller. An IPG's interactive menus are generated within local receiving or display equipment by using scheduling data sent by individual stations and/or centralized scheduling information providers.

“Enhanced Television Binary Interchange Format” (EBIF) means a multimedia content format defined by a specification developed under the OpenCable™ project of CableLabs™. The primary purpose of EBIF is to represent an optimized collection of widget and byte code specifications that define one or more multimedia pages, similar to web pages, but specialized for use within an enhanced television (ETV) or interactive television system. An EBIF file (e.g., a sequence of bytes that conforms to the EBIF content format) forms the primary information contained in an ETV Application. An ETV User Agent acquires, decodes, presents, and executes actions contained in an EBIF file in order to present a multimedia page to an end-user. Other types of more specialized EBIF files play auxiliary roles to this principal role of encoding viewable and interactive pages. U.S. patent application having docket number UV-524A, by Walter Richard Klappert, entitled “Systems and Methods for Providing Interactive Content during Writing and Production of a Media Asset”, which is herein incorporated by reference, provides an example of television equipment and an electronic program guide that comport with EBIF.

“Fingerprint” (e.g., “audio fingerprint”, “acoustic fingerprint” or “digital fingerprint”) means a digital measure of certain properties of an audio and/or visual signal (e.g., audio/visual data). A fingerprint typically includes a fuzzy representation of an audio waveform generated by applying, for example, a Fast Fourier Transform (FFT) to the frequency spectrum contained within the audio waveform. A fingerprint may be used to identify data, and/or to locate similar items in a database. A fingerprint typically operates as an identifier for a particular item, such as, for example, content information, media content, a track, a song, a recording, an audio book, a CD, a DVD and/or a Blu-ray Disc. A fingerprint is an independent piece of data that is not affected by content information. A company like Rovi™ Corporation may have databases that store over 100 million unique fingerprints for various content information. Practical uses of fingerprints include without limitation identifying content information, songs, identifying recordings, identifying melodies, identifying tunes, identifying advertisements, monitoring broadcasts, monitoring peer-to-peer networks, managing media libraries and/or identifying media files.

“Fingerprinting” is the process of generating a fingerprint for an audio and/or visual waveform. U.S. Pat. No. 7,277,766 (the '766 patent), entitled “Method and System for Analyzing Digital Audio Files”, which is herein incorporated by reference, provides an example of an apparatus for fingerprinting an audio waveform. U.S. Pat. No. 7,451,078 (the '078 patent), entitled “Methods and Apparatus for Identifying Media Objects”, which is herein incorporated by reference, provides an example of an apparatus for generating a fingerprint of an audio chapter. U.S. patent application Ser. No. 12/456,177 (the '177 patent application), entitled “Managing Metadata for Occurrences of a Chapter”, which is herein incorporated by reference, provides an example of identifying metadata by storing an internal identifier (e.g., fingerprint) in the metadata (e.g., content information).

“Identifier” means a key that is used to organize, identify, and/or retrieve data in a database. For example, an identifier may be a pointer that points to regional content information in a database. Content information is defined above. As another example, an identifier may be a fingerprint that is associated with regional content information in a database. Fingerprint is defined above.

“Media content” means audio and/or visual content. Examples of media content include without limitation a television program, a television broadcast, a satellite transmission, a cable transmission, an on-demand program, a network stream, an Internet stream, audio and/or visual content.

“Network” means a connection, which permits the transmission of data, between any two or more computers. A network may be any combination of networks, including without limitation a local area network, a wide area network, a network of networks, the Internet, a cable network, a satellite network, a wireless network, a cellular network, and/or a home media type network.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, are implemented as a series of software instructions for being operated by a processor, such that the embodiments are implemented as software, hardware or a combination thereof. Computer readable media are described in more detail in a separate section below.

“System” means a device and/or multiple coupled devices. A device is defined above.

“User” means an operator of a computer. A user may include without limitation a consumer, an administrator, a client, client device, and/or user device in a marketplace of products and/or services.

“User device” (e.g., “client”, “client device”, and/or “user computer”) is a hardware system, a software operating system and/or one or more software application programs. A user device may refer to a single computer and/or to a network of interacting computers. A user device may be the client part of a client-server architecture. A user device typically relies on a server to perform some operations. Examples of a user device include without limitation a television, set-top box, a laptop computer, a palmtop computer, a smart phone, a cell phone, a mobile phone, a display, a database, a server, a compact disc (CD) player, a digital video disc (DVD) player, a Blu-ray Disc player, a personal media device, a portable media player, an iPod™, a Zune™ Player, an mp3 player, a digital audio recorder, a digital video recorder, an IBM-type personal computer (PC) having an operating system such as Microsoft Windows™, an Apple™ computer having an operating system such as MAC-OS, hardware having a JAVA-OS operating system, and/or a Sun Microsystems Workstation having a UNIX operating system.

“Web browser” means any software program that can display text and/or graphics from Web pages on Web sites. Examples of a Web browser include without limitation Mozilla Firefox™ and Microsoft Internet Explorer™.

“Web page” means any documents written in mark-up language including without limitation HTML (hypertext mark-up language), VRML (virtual reality modeling language), dynamic HTML, XML (extended mark-up language) and/or related computer languages thereof, as well as to any collection of such documents reachable through one specific Internet address or at one specific Web site, or any document obtainable through a particular URL (Uniform Resource Locator).

“Web server” refers to a computer and/or another electronic device that is capable of serving at least one Web page to a Web browser. An example of a Web server is a Yahoo™ Web server.

“Web site” means at least one Web page, and more commonly a plurality of Web pages, virtually coupled to form a coherent group.

“Widget” (e.g., TV widget) means a controlling device and/or the graphic component of the controlling device. A widget is a generic term that may refer to the program that is configured for making a graphical user interface (GUI) look and perform in a specified way, depending on what action the user takes while interfacing with the GUI. A widget may also refer to the part of a GUI that allows the user to interface with an application and/or operating system. Widgets may display information and/or invite the user to act in a number of ways. A widget may configure a web-enabled television with the ability to communicate over the Internet and/or another network. Typical widgets include buttons, dialog boxes, pop-up windows, pull-down menus, icons, scroll bars, resizable window edges, progress indicators, selection boxes, windows, tear-off menus, menu bars, toggle switches, and/or forms.

### General Overview

Media content (e.g., television program, Internet stream, etc.) is frequently distributed globally. It is increasingly difficult for producers of media content to consider how certain media content may not be culturally understandable to some users of the media content. The system provides explanations of cultural peculiarities to a user device as the peculiarities occur in the original media content.

The system is configured for providing a content information message for display on a user device. The system predicts a user's culture by using one or more user settings, including without limitation the indicated location of the user device. Based on the user settings and the media content being shown, the system then provides regional content information for making the media content culturally understandable for the user of the user device.

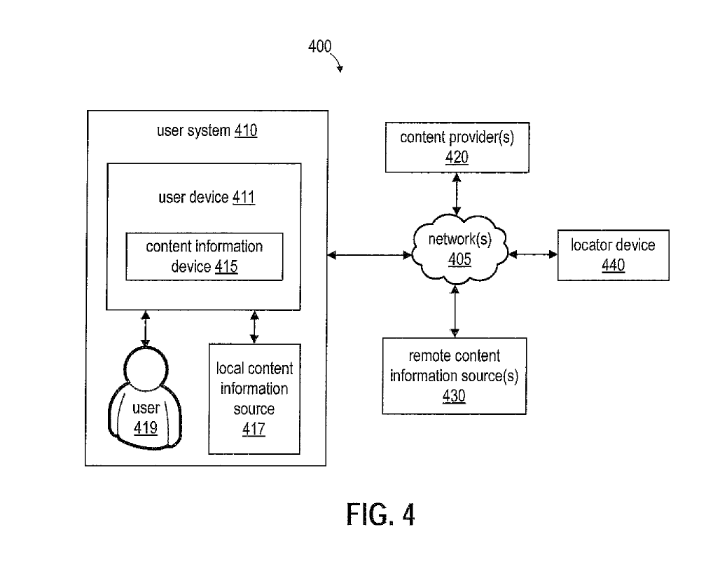

The content information message may include trivia or useful information associated with, for example, regional, topical and/or cultural idiosyncrasies mentioned, or shown, in the television program. The content information message may be presented as, for example, a pop-up message and/or a message with a text scrolling feature. The feature for providing a content information message may be turned on or off. Portions of the system may be implemented via, for example, a widget and/or a TV widget, as described below with reference to FIG. 4. There are other implementations as well, as described below with reference to the appropriate figures.

### Example Output

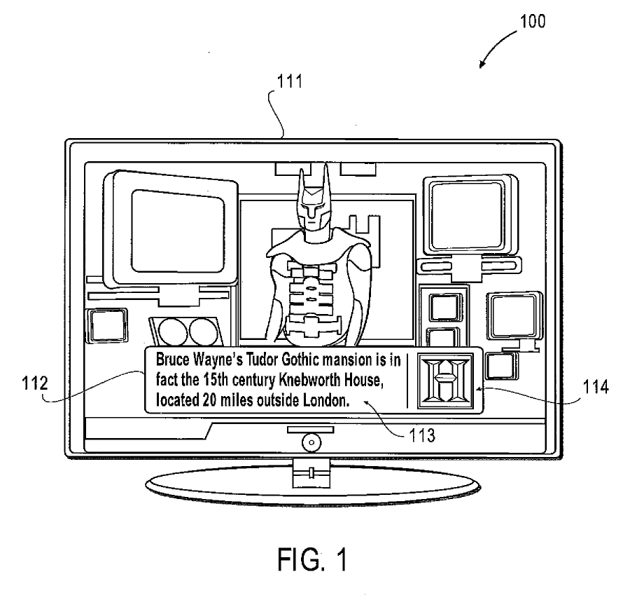

FIG. 1 shows a user device 111 that displays an example of output of operations of a system 100, in accordance with some embodiments. In this example, the output is a content information message 112 that includes content information 113 and an ad space 114.

The content information message 112 is, in this example, a pop-up message. The content information message 112 is an enlarged version of what appears on the display of the user device 111. The content information 113 includes information about the media content that is being transmitted to the user device 111. The content information 113 is associated with the media content and predetermined user settings, including the indicated location of the user device 111. In this case, the media content is a version of the movie Batman. The content information 113 includes the following information: “Bruce Wayne's Tudor Gothic mansion is in fact the 16^{th} century Knebworth House, located 20 miles outside London.”

The system 100 preferably provides the content information 113 in the same language as the predominant language of the media content. However, the system 110 may be configured for providing the regional content information in a language that is different than the predominant language in the media content.

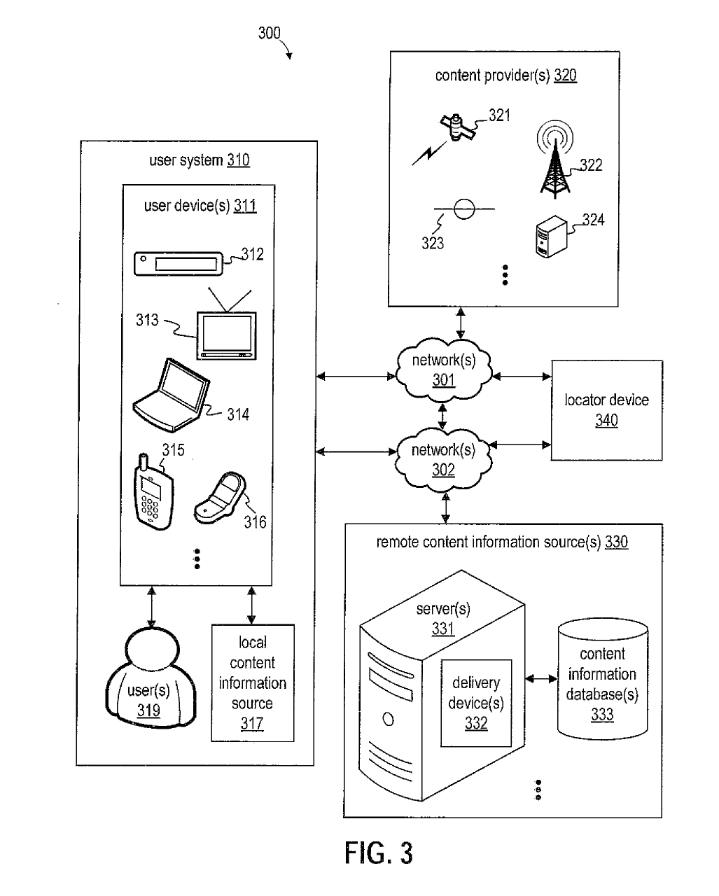

The ad space 114, in this example, includes the logo for the History Channel. The ad space 114 is optional. The ad space 114 allows an advertiser to advertise a product and/or service by paying a content provider and/or content information source in return for use of the ad space 114. Accordingly, the ad space 114 may generate revenue for a content provider and/or a content information source, which are described below with reference to FIG. 3. An advertisement in the ad space 114 should be contextually relevant to the content information content in the content information message 112. Otherwise, users will likely lose trust with the system 100 and/or the advertisers.

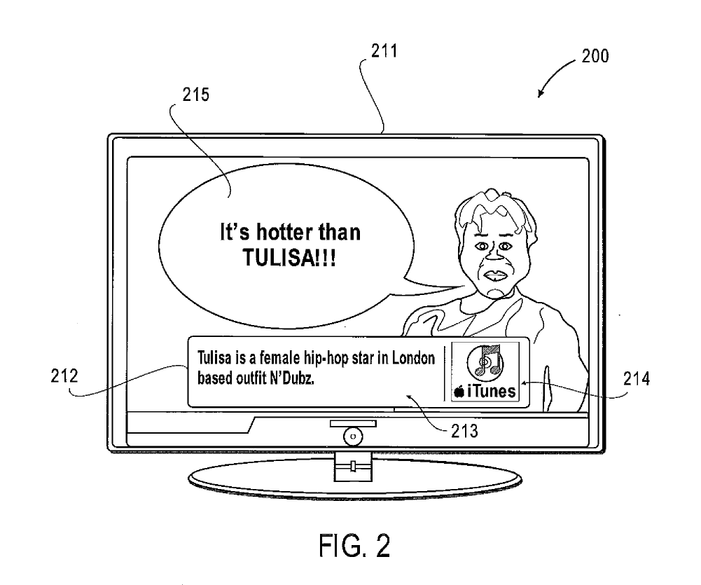

FIG. 2 shows a user device 211 that displays another operation of a system 200, in accordance with some embodiments. In this example, the output is a content information message 212 that includes content information 213 and an ad space 214. The ad space 214 includes, in this example, the logo for iTunes™.

The content information message 212 is, in this example, a pop-up message. The content information message 212 is an enlarged version of what appears on the display of the user device 211. The content information 213 includes information about the media content that is being transmitted to the user device 211. In this case, the media content is an episode of the television show “Hell's Kitchen”. The media content includes a statement 215 by the host of the show. The host is saying, “It's hotter than TULISA!!!”. This particular statement happens to be easily understandable for people who are familiar with British pop culture. However, the statement is likely to be misunderstood by users who are unfamiliar with British pop culture.

Accordingly, for a user device that is not located near Great Britain, the system may be configured for providing content information 213, which includes the following information: “TULISA is a female hip-hop star in London based outfit N-Dubz.” The content information 213 is associated with the statement 215 from the media content. The content information 213 is also associated with predefined user settings, including the indicated location of the user device 211.

The content information messages that are illustrated in FIG. 1 and FIG. 2 are example results of operations of the system. The system is described in more detail in the following sections.

### Architecture Overview

FIG. 3 is a block diagram of a system 300 configured for providing regional content information to a user system 310, in accordance with some embodiments. The system 300 includes without limitation one or more networks a user system 310, one or more content providers 320, one or more remote content information sources 330 and a locator device 340. Each device of the system 300 has functionality that is described below with reference to the appropriate figures.

The user system 310 includes one or more user devices 311 that are configured to receive input from one or more users 319. Examples of a user device 311 include without limitation a set-top box 312, a television 313, a laptop 314, a smart phone 315 and/or a cell phone 316, among other user devices. One or more user devices 311 may be coupled to (or may include) a local content information source 317.

The one or more user devices 311 may be coupled to the same network or, alternatively, to different networks. For instance, the user devices 313, 314, 315 and 316 may be coupled to a first network 301, while the user device 312 may be coupled to a second network 302. The networks 301 and 302 may include a variety of network types, such as, for example, local area networks, wide area networks, networks of networks, the Internet, cable networks, satellite networks, wireless networks, cellular networks, and/or home media type networks. In some embodiments, the first network 301 is coupled to the second network 302.

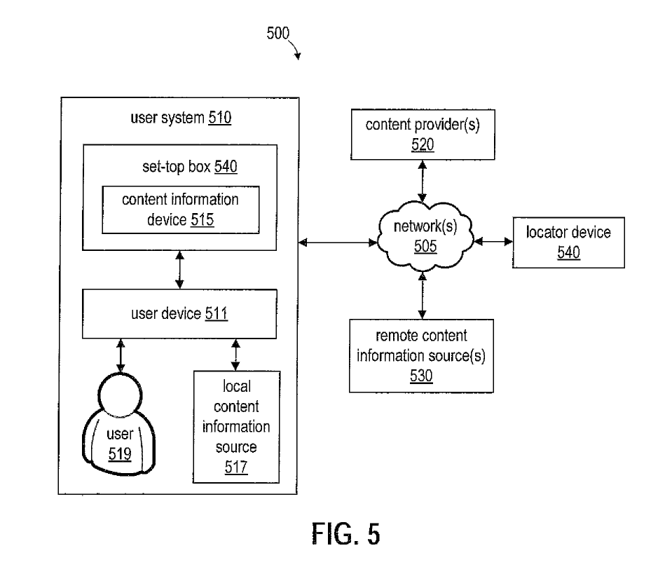

The one or more content providers 320 are coupled to the one or more networks 301 and/or 302. The one or more content providers 320 may include without limitation a satellite television provider 321, a television broadcaster 322, a cable television provider 323, and/or a streaming content provider 324. Examples of a content provider include without limitation DirecTV™, NBC™, Comcast™, Youtube™, and Verizon™. A content provider 320 may send, to the user system 310, media content, content information and/or an identifier for content information. The content provider 320 may also send, to a remote content information source 330, media content, content information and/or an identifier for content information. The media content may include a comprehensive delivery of all available content in the area, and all available languages for the media content. The user system 310 and/or the remote content information source 330 may filter the comprehensive delivered content according to the configuration of a content information device, a set-top box and/or other controller devices. Content information devices and set-top boxes are further described below with reference to FIG. 4 and FIG. 5.

The one or more remote content information sources 330 are coupled to the one or more second networks 302. The remote content information sources 330 may include without limitation one or more servers 331. The one or more servers 331 include without a delivery device 332 configured for delivering content information and/or identifiers for content information to the one or more content providers 320 and/or to the one or more user devices 311. Examples of a remote content information source 330 include without limitation Rovi™ Corporation, Google™, and Yahoo™.

The one or more servers 331 are coupled to one or more content information databases 333. A content information database 333 may store, among other things, content information that is associated with media data from a content provider 320. The system 200 may originally obtain such content information from various content information sources, including, for example, administrator devices, robotic devices and/or user devices, among other sources. An example of an administrator device is an administrator computer for an administrator of the system 200. An example of a robotic device is a robot that scans the Internet for content information.

The content information database 333 is preferably organized according to identifiers (e.g., pointers, fingerprints, etc.). For example, the content information database 333 may store a list of fingerprints that are each linked to content information for particular media content. Other databases, such as databases coupled to a content provider 320, may store media content.

U.S. patent application Ser. No. 12/774,592 (the '592 patent application), entitled “Recommending a Media Item by Using Audio Content from a Seed Media Item”, which is herein incorporated by reference, provides an example of a system for storing content information associated with media in a database. U.S. Patent Publication No. 20070288478 (the '478 patent publication), entitled “Method and System for Media Navigation”, which is herein incorporated by reference, provides an example of a method for navigating and searching for content information on a database.

The local content information source 317 is configured for performing operations that are similar to the operations of a remote content information source 330. However, the local content information source 317 is configured for performing important operations locally at the user system 310. The local content information source 317 is configured for receiving content information and/or identifiers for content information from the remote content information source 330. Such content information may be received periodically (e.g., hourly, daily, weekly, monthly, yearly, etc.).

The local content information source 317 may then provide content information to a user device 311, especially while the user device 311 is offline from a network 302. Accordingly, in some embodiments, a user device 311 is offline, and does not have to be coupled to a network 302, while receiving content information because of the local content information source 317. The local content information source 317 provides, among other things, a technical safeguard for dropouts in a connection to a network 302 (e.g., the Internet). An example of a local content information source 317 is a personal computer and/or another user device 311 that has content information received from a remote content information source 330 and has stored the content information for future operations of the system 300.

The locator device 340 is coupled to one or more first networks 301 and/or to one or more second networks 302. The locator device 340 is configured for locating one or more user devices 311. An example of a locator device 340 is an Internet service provider (ISP).

It will be readily appreciated that the block diagram of FIG. 3 is for explanatory purposes, and that numerous variations are possible. For example, the system 300 may include a database (or system of databases) arranged in a configuration that is different than the databases depicted here. Other example configurations are illustrated in FIG. 4 and FIG. 5 below. Other configurations exist as well.

### Architecture Examples

FIG. 4 is a block diagram of a system 400 configured for providing regional content information to a user system 410, including a user device 411 having a content information device 415, in accordance with some embodiments. The system 400 is configured in a manner similar to the system 300 of FIG. 3. As shown in FIG. 4, the system includes without limitation one or more networks 405 coupled to the user system 410, one or more content providers 420, one or more remote content information sources 430 and a locator device 440.

The user system 410 includes without limitation a user device 411 and a local content information source 417. The user device 411 includes without limitation a content information device 415. The user device 411 is configured for receiving input from a user 419. The user device 411 may be couple to, or may include, a local content information source 417.

The content information device 415 is configured for carrying out important operations of the system 400. The content information device 415 may be software and/or hardware on the user device 411. The user device 411 may include, for example, a laptop, a cell phone, a smart phone and/or another device. An example of a content information device 415 is a widget (e.g., TV widget) where the user device 411 is, for example, a television. A widget is a controlling device and/or the graphic component of the controlling device.

The content information device 415 may include without limitation an Enhanced Television Binary Information Format (EBIF) application, which is a multimedia content format defined by a specification developed under the OpenCable™ project of CableLabs™. The primary purpose of EBIF is to represent an optimized collection of widget and byte code specifications that define one or more multimedia pages, similar to web pages, but specialized for use within an enhanced television (ETV) or interactive television system.

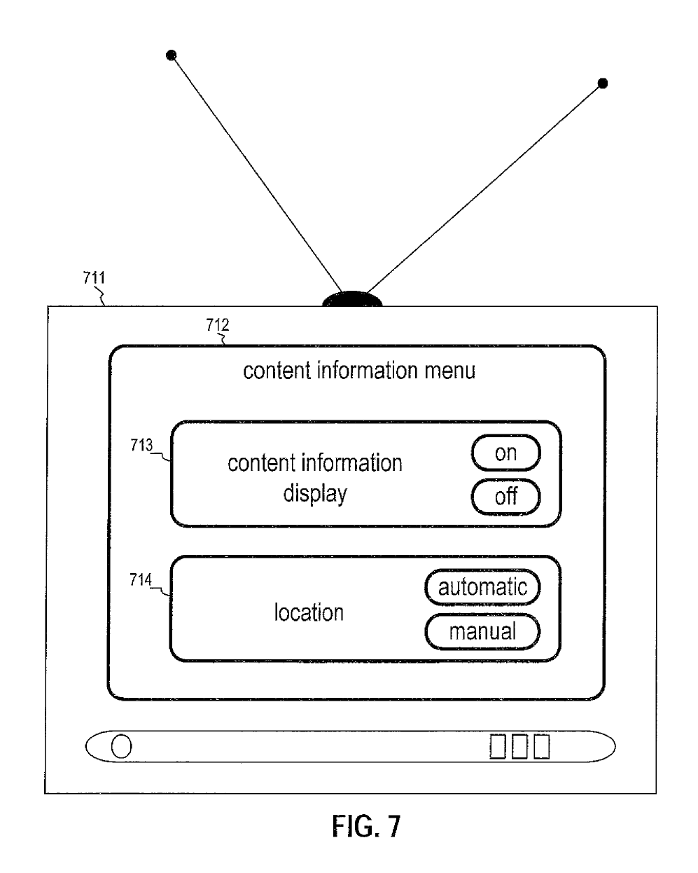

A content information menu for the content information device 415 may be presented to a user via an electronic program guide (EPG) or by another delivery means. An EPG is a digitally-displayed menu of program scheduling information shown by a content provider (e.g., cable provider or satellite TV provider) to its subscribers on a dedicated channel. The EPG may include an interactive program guide (IPG), which is an interactive form of program guide. An IPG allows television users and radio listeners to navigate scheduling information menus interactively, selecting and discovering programming by time, title, station, and/or genre using an input device such as a keypad, computer keyboard, or TV remote controller. Content information menus are described below with reference to FIG. 7 through FIG. 9.

FIG. 5 is a block diagram of a system 500 configured for providing regional content information to a user system 510, including a set-top box 540 having a content information device 515, in accordance with some embodiments. The system 500 is configured in a manner similar to the system 300 of FIG. 3. As shown in FIG. 5, the system 500 includes without limitation one or more networks 505 coupled to the user system 510, one or more content providers 520, one or more remote content information sources 530 and a locator device 540. The user device 511 is configured for receiving input from a user device 519. The user device 511 may be coupled to, or may include, a local content information source 517.

The content information device 515 is configured for carrying out more important operations of the system 500. The content information device 515 may be software and/or hardware on the user device 511, which may include, for example, a laptop, a cell phone, a smart phone and/or another device. For example, the content information device 515 may be software and/or hardware located in the set-top box 540.

Like the content information device 415 of FIG. 4, the content information device 515 of FIG. 5 may include without limitation an EBIF application. A content information menu for the content information device 515 may be presented to a user via an electronic program guide (EPG) or by another delivery means. Content information menus are described below with reference to FIG. 7 through FIG. 9.

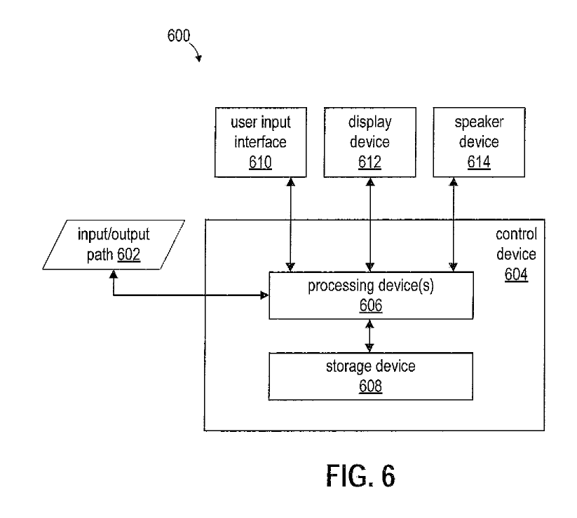

FIG. 6 is a block diagram of generalized user system 600, in accordance with some embodiments. More specific implementations of user systems are described above with reference to FIG. 4 and FIG. 5. The user system 600 of FIG. 6 includes without limitation a control device 604, a user input interface 610, a display device 612 and a speaker device 614. The control device 604 includes without limitation a processing device 606 and a storage device 608. The one or more processing devices 606 are coupled to the user input interface 610, the display device 612, the speaker device 614, the storage device 608 and an input/output path 602. The one or more processing devices 606 may include without limitation one or more microprocessors, microcontrollers, digital signal processors and/or programmable logic devices.

The user system 600 is configured for receiving, via the input/output path 602, data and/or media content. Examples of media content include without limitation television program, a television broadcast, a satellite transmission, a cable transmission, a network stream, and an Internet stream. The media content may include pre-recorded content (e.g., pre-recorded content from a content provider, or pre-recorded content from a digital video recorder) and/or substantially live content (e.g., live broadcast of the Superbowl). The input/output path 602 is configured for providing media content and/or data to the control device 604. The control device 604 is configured for sending and/or receiving commands, requests and/or other suitable data by using the input/output path 602. The input/output path 602 may couple the control device 604, specifically the processing device 606, to one or more communications paths, such as, for example, the networks 301 and 302 of FIG. 3. The input/output functions may be provided by one or more of these communications paths, but are shown as a single path in FIG. 6 to avoid overcomplicating the drawing.

In some embodiments, the control device 604 is configured for executing instructions for a content information device. Examples of a content information device are described above with reference to FIG. 4 and FIG. 5. The control device 604 may include without limitation a cable modem, an integrated services digital network (ISDN) modem, a digital subscriber line (DSL) modem, a telephone modem and/or a wireless modem for communicating with other devices. Such communicating may involve the communicating over a network, which may include without limitation a local area network, a wide area network, a network of networks, the Internet, a cable network, a satellite network, a wireless network, a cellular network, and/or a home media type network. The control device 604 may further include without limitation a device that enables peer-to-peer communication with other user devices and/or communication with user devices in locations remote from each other. In some embodiments, the control device 604 is configured for receiving an interactive table of contents with computer language instructions and/or time indicators. A content information device may be configured for using the interactive table of contents to determine at what point in media content to execute computer language instructions for causing the display of content information, media content and/or other data.

The storage device 608 may include without limitation a memory (e.g., random-access memory, read-only memory and/or other memory), a hard drive, an optical drive, a removable storage device (e.g., DVD recorder, CD recorder, video cassette recorder and/or other suitable recording device) and/or other storage device. For example, user system 600 may include a digital video recorder (DVR) and a DVD recorder as a secondary storage device. The storage device 608 may be used to store various types of data, including without limitation content information, user settings, media content, program information, and/or other data used in operating the system. The storage device 608 may also include nonvolatile memory, for example, to launch boot-up routines and/or other instructions. The storage device 608 may be used to store an interactive table of contents and/or time indicators received over the input/output path 602.

The control device 604 may include a video generating device and a receiver, such as, for example, one or more analog tuners, one or more Moving Pictures Experts Group-2 (MPEG-2) decoders, another digital decoding device, high-definition tuners, another tuning device, and/or another video device. An encoding device (e.g., for converting over-the-air, analog, or digital signals to MPEG signals for storage) may also be provided. The control device 604 may also include a scaler device for up-converting and down-converting media into the preferred output format of the user system 600. The control device 604 may also include a digital-to-analog converter device and/or an analog-to-digital converter device for converting between digital and analog signals. The user system 600 may use the receiver and the encoding device to receive, display, play and/or record media content. The user system 600 may also use the receiver and the encoding device to receive content information and/or media content. The control device 604, which may be configured for tuning, video generating, encoding, decoding, scaling, analog-to-digital converting and digital-to-analog converting, may be implemented by using software configured for running a general purpose processor and/or a special purpose processor. Multiple receiver devices may be provided to handle simultaneous functions, such as, for example, watch function, record functions, picture-in-picture (PIP) functions, multiple-tuner recording, etc. If the storage device 608 is provided as a separate device from the user system 600, the receiver device and the encoding device (including multiple tuners) may be associated with the storage device 608. In some embodiments, the control device 604 is configured for executing computer language instructions corresponding to the interactive table of contents and may cause the display of interactive content with the media content. The control device 604 may process input from the user corresponding to the displayed interactive content.

The control device 604 is configured for control by a user via the user input interface 610. The user input interface 610 may be any suitable user interface, such as, for example, a remote controller, mouse, trackball, keypad, keyboard, touch screen, touch pad, stylus input, joystick, voice recognition interface, or other user input interfaces. The display device 612 may be provided as a stand-alone device or integrated with other elements of the user system 600. Examples of a display device 612 include without limitation a monitor, a television, a liquid crystal display (LCD) for a mobile device, and/or any other equipment for displaying visual images. In some embodiments, the display device 612 is compatible with high-definition television (HDTV). The speaker device 614 may be provided as integrated with other elements of the user system 600 or may be one or more standalone units. The user system may play, through the speaker device 614, the audio component of videos and/or other media content displayed on the display device 612. In some embodiments, the audio is distributed to an audio receiver (not shown), which processes and outputs the audio via the speaker device 614. In some embodiments, the user system 600 is configured for using the user input interface 610 to provide responses to interactive content provided on the display screen.

The content information device may be implemented using any suitable architecture. For example, the content information device may be a stand-alone application wholly implemented on the user system 600 (e.g., a set-top box). In such an approach, instructions of the application are preferably stored locally, and data for use by the application is downloaded on a periodic basis (e.g., from the vertical blanking interval (VBI) of a television channel, from an out-of-band feed, or from another device). In another embodiment, the content information device is a client-server based application. The user system 600 retrieves data, on-demand by issuing requests to a remote server, for use by a client implemented on the user system 600. In one example of a client-server based content information device, the control device 604 runs a web browser that interprets web pages provided by a remote server.

In some embodiments, the content information device is downloaded and interpreted or otherwise run by an interpreter or virtual machine, which is run by the control device 604. In some embodiments, the content information device is encoded in the Enhanced Television Binary Interchange Format (EBIF), received by the control device 604 as part of a suitable feed, and interpreted by a user agent running on the control device 604. The content information device may be, for example, an EBIF widget and/or a TV widget. In other embodiments, the content information device is defined by a series of JAVA-based files that are received and run by a local virtual machine or other middleware executed by the control device 604. In some of such embodiments, for example, embodiments employing MPEG-2 or other digital media encoding schemes, the content information device may be, for example, encoded and transmitted in an MPEG-2 object carousel with the MPEG audio and video packets of a program.

In some embodiments, the system 600 includes a digital media controller (DMC). A digital media controller is a device that finds media content and/or content information on a digital media server, and instructs a digital media renderer (DMR) to play the media content and/or content information. Examples of a digital media controller include without limitation an Apple iPad™, an Apple iPhone™, a Motorola Droid™, a smart phone, a mobile phone, and/or a cell phone. Examples of a digital media server include without limitation a content information source and a content provider. Examples of a digital media renderer include without limitation a web enabled television, a desktop computer and a laptop computer. For instance, the system 600 may include an Apple iPad™ that is in communication with a content information source, a content provider and/or a web-enabled television. The Apple iPad™ may allow a user to interface with a content information device via menus, such as the menus that are described below with reference to FIG. 7 through FIG. 9.

### Menu Interface

FIG. 7 is an example of a user device 711 displaying a content information menu 712, in accordance with some embodiments. The content information menu 712 includes without limitation a graphical user interface for interacting with and configuring the content information device in the user device 711. The content information menu 712 configures the user device 711 for receiving, from a user, input for user settings. The content information menu 712 may provided by a content information device that includes a widget (e.g., TV widget), as described above with reference to FIG. 4. The content information menu 712 is configured for receiving input by one or more graphical user interface (GUI) devices, such as, for example, buttons, dialog boxes, pop-up windows, pull-down menus, icons, scroll bars, resizable window edges, progress indicators, selection boxes, windows, tear-off menus, menu bars, toggle switches, and/or forms. The content information menu 712 includes without limitation a content information display setting 713 and a location setting 714 for the user device 711.

The content information device in the user device 711 may be enabled or disabled via the content information display setting 713. If the content information display setting 713 is set to “off”, then the content information device is configured for not providing content information for display on the user device 711. If the content information display setting 713 is set to “on”, then the content information device is configured for providing content information for display on the user device 711.

The location of the content information device may be determined automatically or manually. If the location setting 714 is set to “automatic”, then the content information device is configured for determining automatically the location of the user device 711. For example, a locator device may determine the location of the user device 711. One example of a locator device is an Internet service provider (ISP), which may determine the general location of a user device 711 for which the ISP provides Internet service.

On the other hand, if the location setting 714 is set to “manual”, then the content information device is configured for receiving manually inputted location information. For example, a user may press the “manual” button on the content information menu 712 and enter location information by using a graphical user interface of the content information menu 712. It is important to note that the user does not necessarily have to input the actual location of the user device. The user may input any location. The user device 711 is configured for receiving any manually inputted location. For example, the user and user device 711 may be located in London, but the user may want to receive content information associated with San Francisco. In such a case, the user may input “San Francisco” as the location for the user device, even though the user device is located in London while the user is viewing media content on the user device.

In some embodiments, the content information menu 712 may include options for controlling picture-in-picture (PIP) functionality. A content information message may be displayed within one of multiple frames being displayed on the user device 711. For example, media content may be displayed on one frame of the picture-in-picture, while content information message is displayed on another frame of the picture-in-picture. In another example, both the media content and the content information message may be displayed simultaneously on one frame of the picture-in-picture.

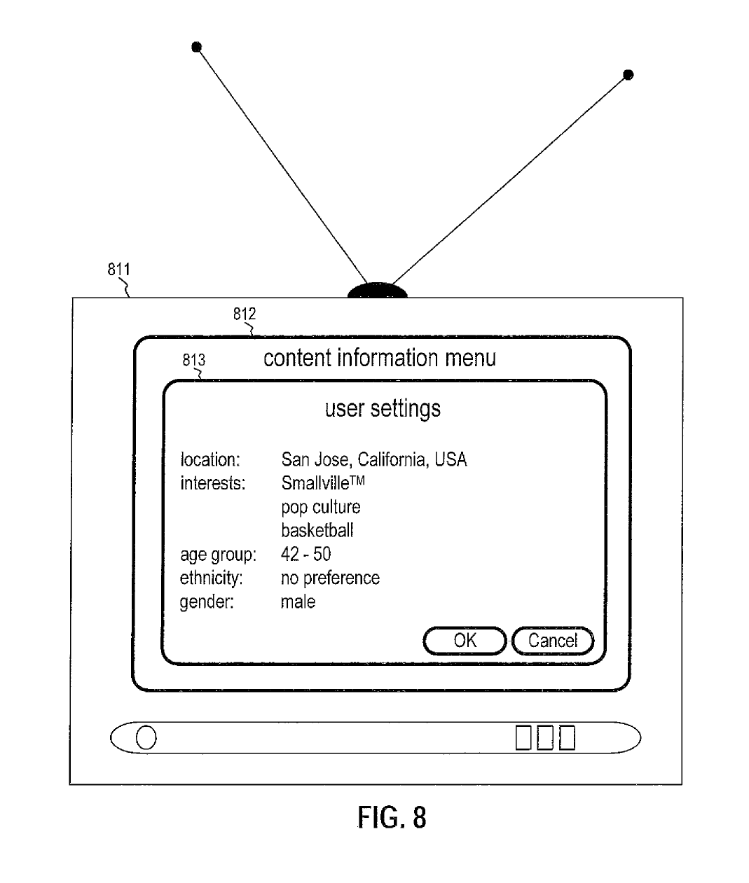

FIG. 8 is an example of a user device 811 displaying a content information menu 812 that includes without limitation controls for user settings 813, in accordance with some embodiments. The content information menu 812 includes without limitation a graphical user interface for interacting with and setting controls for the content information device. The user settings indicate the type of content information that the user would like to be displayed alongside incoming content information content. The content information messages to be displayed on the user device 811 may include without limitation trivia and/or other facts that are associated with the incoming media content and the user settings. In this example, the content information menu 812 is configured for receiving user settings 813 that include location, interests, age group, ethnicity and gender. In another embodiment, the content information menu 812 is configured for receiving other user settings. The location may be set automatically or manually, as described above with reference to FIG. 7.

The “interests” may include without limitation preferences associated with, for example, pop culture, religion, history, production trivia and/or other preferences. In the example of FIG. 8, the user interests are set to include Smallville™, pop culture and basketball. The age group is set to the “42-50” years old age group. The ethnicity is set to “no preference”. The gender is set to “male”.

A user may accept the user settings 813 and any changes to the user settings 813, for example, by pressing an “OK” button on the content information menu 812. Alternatively, a user may reject any changes to the user settings 813, for example, by pressing a “Cancel” button on the content information menu 812.

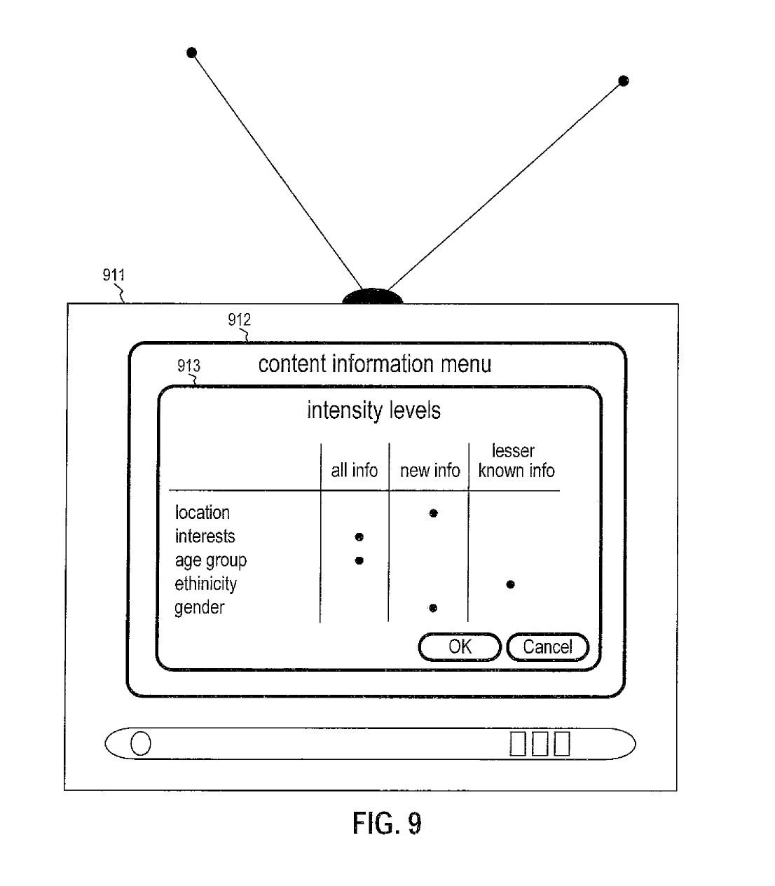

FIG. 9 is an example of a user device 911 displaying a content information menu 912 that includes controls for setting intensity levels 913 for content information messages, in accordance with some embodiments. The intensity levels may be manually set by the user to specify how many and what kind of facts the user would like to receive at the user device 911. In this example, for each of the categories of user settings, the content information menu is configured for receiving one of the following intensity levels: “All Info”, “New Info”, or “Lesser Known Info”. For instance, a history buff may not need to be told the start date of the American Civil War, but may want to see lesser known information like where Grant and Lee did their military training. There are other intensity levels as well.

A user who loves the History Channel may opt to leave on the historical references feature for all programs they watch, providing that user with two levels of simultaneous entertainment, including (1) the original content as received from a content provider and (2) the stream of historical facts content information that is associated with that original content. An aspiring filmmaker may do the same for cinematically-related production notes. In another example, a BBC America fan may turn up the intensity (e.g., set intensity to “All Info”) on the pop cultural references in order to understand quickly who the celebrities are on British talk shows by reading content information displays that appear immediately under the guests as they walk on stage.

A user may accept the intensity levels 913 and any changes to the intensity levels 913, for example, by pressing an “OK” button on the content information menu 912. Alternatively, a user may reject any changes to the intensity levels 913, for example, by pressing a “Cancel” button on the content information menu 912.

As explained above, the system is configured for providing content information messages for display on a user device. The description below further details various ways for providing one or more content information messages for display on a user device.

User Device Receiving Content Information from a Content Provider

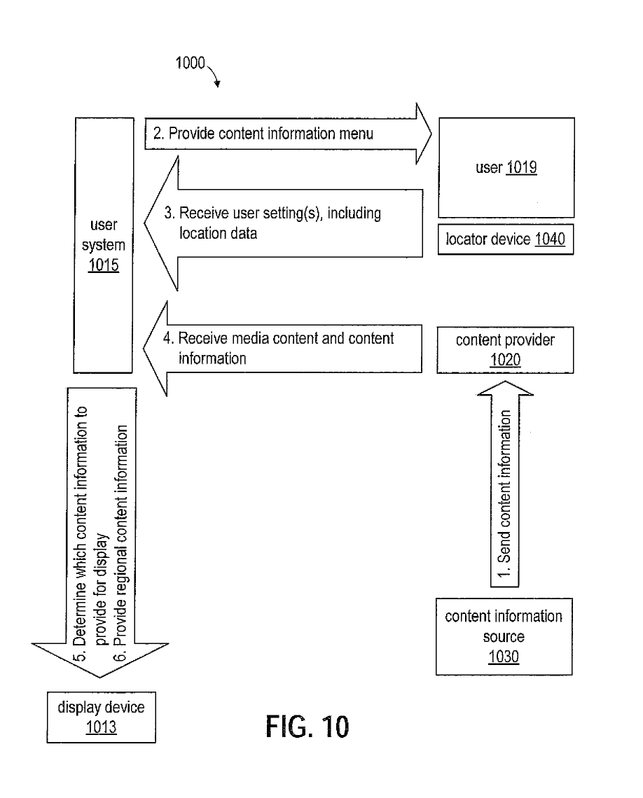

FIG. 10 is a diagram of a system 1000 configured for providing regional content information to a user system 1015, wherein a content provider is a source of content information, in accordance with some embodiments. It will be readily appreciated that the diagram of FIG. 10 is for explanatory purposes, and that numerous variations are possible.

The content information source 1030 is configured for sending content information to a content provider 1020. The content information is preferably associated with media content that the content provider may send to a user system 1015. The content provider 1020 may store the content information in a database system.

The user system 1015 is configured for providing a content information menu that allows a user to interface with a content information device and to control user settings, as described above with reference to FIG. 4 through FIG. 9. The user system 1015 may include, for example, a television that includes a content information device (e.g., widget) for performing important operations of the system 1000, as described above with reference to FIG. 4. In another embodiment, the user system 1015 includes a set-top box that includes a content information device for performing important operations of the system 1000, as described above with reference to FIG. 5.

The user system 1015 is configured for receiving one or more user settings, including location data. The location data may be set automatically and/or manually, as described above with reference to FIG. 7. A locator device 1040 (e.g., Internet service provider) may automatically determine a location of the user system 1015. Alternatively, a user 1019 may manually enter location data. A user 1019 may also enter other user settings (e.g., interests, age group, ethnicity, gender, etc.), as described above with reference to FIG. 8.

The user system 1015 is configured for receiving media content and content information from the content provider 1020. The media content may include, for example, a television program, Internet video and/or content media stream. The content provider 1020 may include a number of different sources (e.g., cable television provider, satellite television provider, television broadcaster, streaming content provider, etc.), as described above with reference to FIG. 3.

The user system 1015 is configured for receiving, from the content provider 1020, the appropriate content information in conjunction with the media content. For example, the media content may have a time code associated with the audio and/or video feed of the media content. The media content may be streamed and/or interweaved with the content information according to a standard for audio and/or video compression and transmission. An example of such a standard is Moving Pictures Experts Group-2 (MPEG-2). In some embodiments, the user system 1015 receives the media content and content information according to Enhanced Television Binary interchange Format (EBIF).

The user system 1015 is configured for determining which content information to provide for display based on the user settings. For example, the user system 1015 may identify one or more items (e.g., production information, pop culture trivia, religion facts, history facts, metadata, and/or annotations) in the content information that are relevant to the user settings. The user system 1015 is configured for receiving the appropriate time code associated with the identified content information. As explained above, the time code is used to synchronize delivery of the media content with the appropriate content information with the media content.

Given the media content and the time code that links the media content with the appropriate content information, the user system 1015 may provide regional content information in a timely manner for display on a display device 1013. It is important to note that the regional content information is intended to be culturally relevant to the location data that is included in the user settings, which are described above with reference to FIG. 7 though FIG. 9. The regional content information may be displayed in a content information message (e.g., pop-up message), as described above with reference to FIG. 1 and FIG. 2.

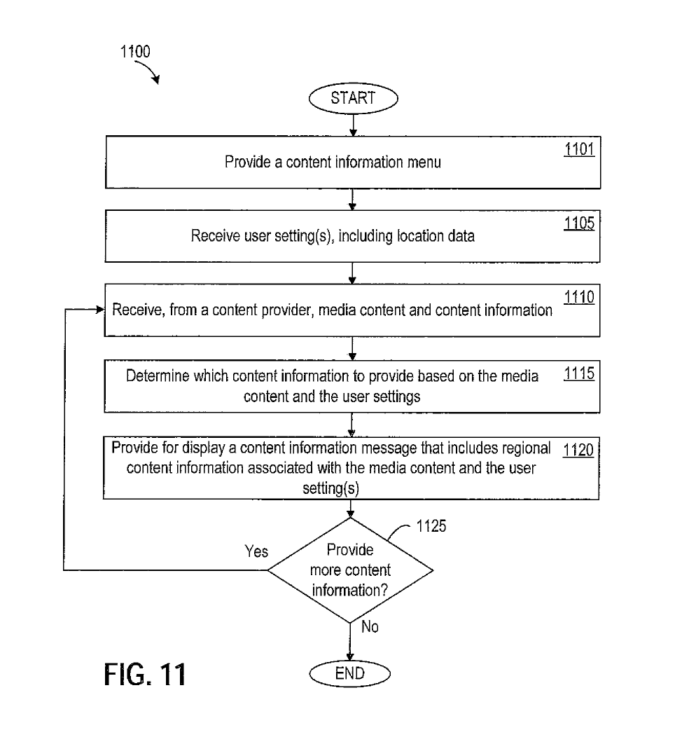

FIG. 11 is a flowchart of a method 1100 for providing regional content information to a user system, wherein a content provider is a source of content information, in accordance with some embodiments. In some implementations, the steps of the method 1100 may be carried out by the content information device 415 of FIG. 4 or by the content information device 515 of FIG. 5. In an implementation, the method 1100 of FIG. 11 operates offline or separately from a content information source and not during a real-time communication with the content information source, for example, over the Internet. In an alternative implementation, the method 1100 operates during a real-time communication with a content information source, for example, over the Internet.

The method 1100 starts in a step 1101 where the system provides a content information menu. For example, the system may provide one or more content information menus that are configured for allowing a user to input user settings with respect to how the user would like to receive regional content information. Examples of content information menus are described above with reference to FIG. 7 through FIG. 9. Next, in a step 1105, the system receives one or more user settings, including location data. For example, the location data may be set automatically or manually, as described above with reference to FIG. 7 through FIG. 9.

The method 1100 moves to a step 1110 where the system receives, from a content provider, media content along with content information. For example, a user device (e.g., television, laptop, etc.) may receive a television program from a content provider (e.g., cable television provider, satellite television provider, etc.), as described above with reference to FIG. 3. The media content may be interweaved with content information, as described above with reference to FIG. 10.

Based on the media content and the one or more user settings, the method 1100 proceeds to a step 1115 where the system determines which content information to provide. For example, a user system may identify one or more items (e.g., production information, pop culture trivia, religion facts, history facts, metadata, and/or annotations) in the content information that are relevant to the user settings, as discussed above with reference to FIG. 10.

Next, in a step 1120, the system provides for display a content information message that includes regional content information associated with the media content and the user settings. For example, a user device may send a pop-up message to a display where the associated media content is being displayed, as described above with reference to FIG. 1 and FIG. 2.

In a decision operation 1125, the system determines if more regional content information is to be provided. If more regional content information is to be provided, then the method 1100 returns to the step 1110 where the system receives more media content and content information. However, if no more regional content information is to be provided, then the method 1100 concludes after the decision operation 1125.

Note that this method 1100 may include other details and steps that are not described in this method overview. Other details and steps are described above with reference to the appropriate figures and may be a part of the method 1100, depending on the embodiment.

User Device Receiving Content Information from a Content Information Source

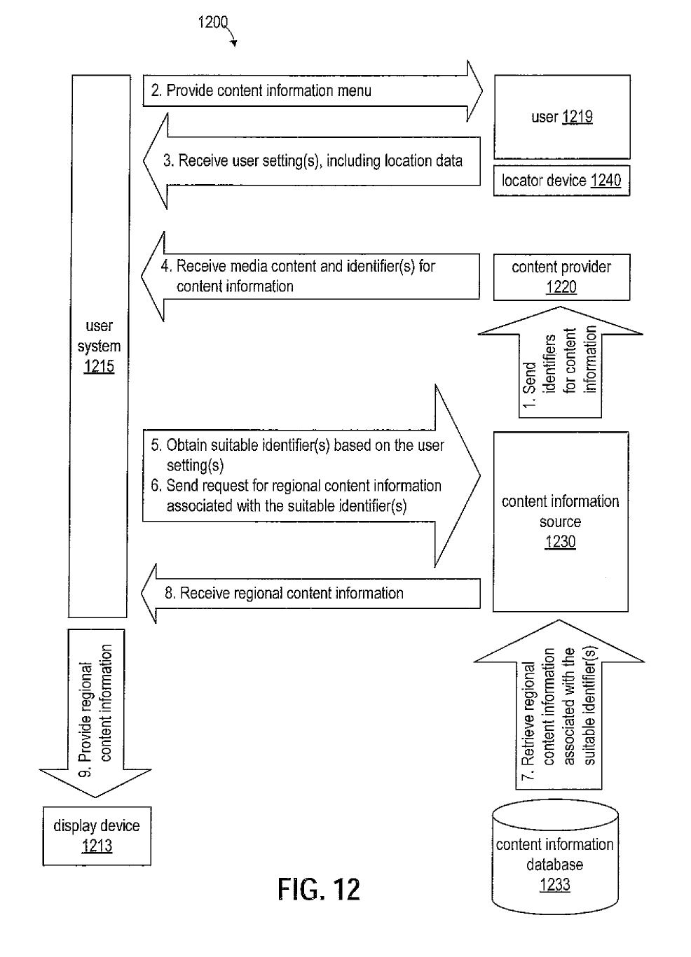

FIG. 12 is a diagram of a system 1200 configured for providing regional content information to a user system 1215, wherein a database system is a source of content information, in accordance with some embodiments. It will be readily appreciated that the diagram of FIG. 12 is for explanatory purposes, and that numerous variations are possible.

The content information source 1230 is configured for sending, to a content provider 1220, identifiers for content information. It is important to note that the content information source 1230 is configured for sending, to the content provider 1220, identifiers for the content information, and not necessarily complete content information. An identifier includes a key that is used to organize, identify, and/or retrieve data in a database. Examples of an identifier include without limitation a pointer and/or a fingerprint. The content information is preferably associated with media content that the content provider may send to a user system 1215. The content provider 1220 may store the content information in a database system.

The user system 1215 is configured for receiving, from the content provider 1220, the appropriated identifiers in sync with the media content. For example, the media content may have a time code associated with the audio and/or video feed of the media content. The appropriated identifiers may be associated with this time code that is, in turn, associated with the media content. The media content may be streamed and/or interweaved with the identifiers according to a standard for audio and/or video compression and transmission. An example of such a standard is Moving Pictures Experts Group-2 (MPEG-2). In some embodiments, the user system 1215 receives the media content and identifiers according to Enhanced Television Binary Interchange Format (EBIF).

The user system 1215 is configured for providing a content information menu, as in the user system 1015 of FIG. 10. The user system is also configured for receiving one or more user settings, including location data, as in the system 1015 of FIG. 10.

In FIG. 12, the content information source 1230 is configured for sending content information to a content provider 1220. The content information is preferably associated with media content that the content provider may send to a user system 1215.

The user system 1215 is configured for receiving, from the content provider 1220, media content and identifiers for content information. It is important to note that the content provider 1220 is configured for sending, to the user system 1215, identifiers for the content information, and not necessarily complete content information. The media content may include, for example, a television program and/or an Internet delivered video. The content provider 1220 may include a number of different sources (e.g., cable television provider, satellite television provider, television broadcaster, streaming content provider, etc.), as described above with reference to FIG. 3.

The user system 1215 is configured for receiving, from the content provider 1220, the appropriated identifiers in conjunction with the media content. For example, the media content may have a time code associated with the audio and/or video feed of the media content. The appropriated identifiers may be associated with this time code. Hence, particular content information may be associated with the media content by using identifiers for the content information. In some embodiments, the user system 1215 receives the media content and identifiers according to Enhanced Television Binary Interchange Format (EBIF). It is important to note that the content provider 1220 is configured for sending, to the user system 1215, identifiers for the content information, and not necessarily complete content information.

Based on the media content and the one or more user settings, the user system 1215 is configured for obtaining suitable identifiers. The user system 1215 obtains suitable identifiers by selecting and/or dynamically generating the suitable identifiers. In some embodiments, the media content may come from the content provider 1220 prepackaged with basic identifying information, such as, for example, identifiers for content information, movie title, producer names, production date, actor names, etc. Accordingly, user system 1215 may select the identifiers by searching the basic identifying information for information associated with the one or more user settings.

In an alternative embodiment, the user system 1215 may dynamically generate identifiers, instead of selecting identifiers. For example, the user system 1215 may generate a fingerprint of media content as the media content is received and/or played. A fingerprint is a measure of certain properties of an audio and/or visual signal (e.g., media content). Examples of techniques for generating an identifier may include without limitation the following: optical character recognition on the media content; video objects recognition on the media content; fingerprint generation from the media content; and application of a Fast Fourier Transform (FFT) to the frequency spectrum contained within an audio signal. For instance, the user device 1215 may generally be configured to recognize the audio portion of media content and then dynamically generate a fingerprint for that audio portion. The fingerprinted audio portion does not necessarily have to be music and may be any type of audio, such as, for example, talking, sound effects, noise, etc. As another example, a television show may contain the song “Amazing Grace” somewhere within the audio and/or video content. The user device 1215 may be configured to recognize a song is playing and then dynamically generate a fingerprint for the song based on a processing of the audio portion of the content.

The user system 1215 is configured for sending, to a content information source 1230, a request for content information associated with the suitable identifiers. The content information source 1230 is configured for receiving such a request for content information. The content information source 1230 may be either remote or local, as described above with reference to FIG. 3. The content information source 1230 is configured for retrieving appropriate content information from a content information database 1233. For example, the content information source 1230 may attempt to match the selected identifiers and/or the dynamically generated identifiers to the identifiers in the content information database 1233. U.S. patent application Ser. No. 16/716,269, which is described above with reference to FIG. 3, provides an example of a method for navigating and searching for content information on a database. The content information database 1233 is configured for pre-storing content information that is associated with identifiers, and is a part of the content information source 1230, as described above with reference to FIG. 3. The content information source 1230 is configured for sending retrieved regional content information to the user system 1215.

Given the media content, the time code that links the identifiers with the appropriate content information, and/or the dynamically generated identifiers, the user system 1215 may provide the regional content information in a timely manner for display on a display device 1213. It is important to note again that the content information is regional content information that is intended to be culturally relevant to the location that is established in the user settings, which are described above with reference to FIG. 7 though FIG. 9. The content information may be displayed in a content information message (e.g., pop-up message), as described above with reference to FIG. 1 and FIG. 2.

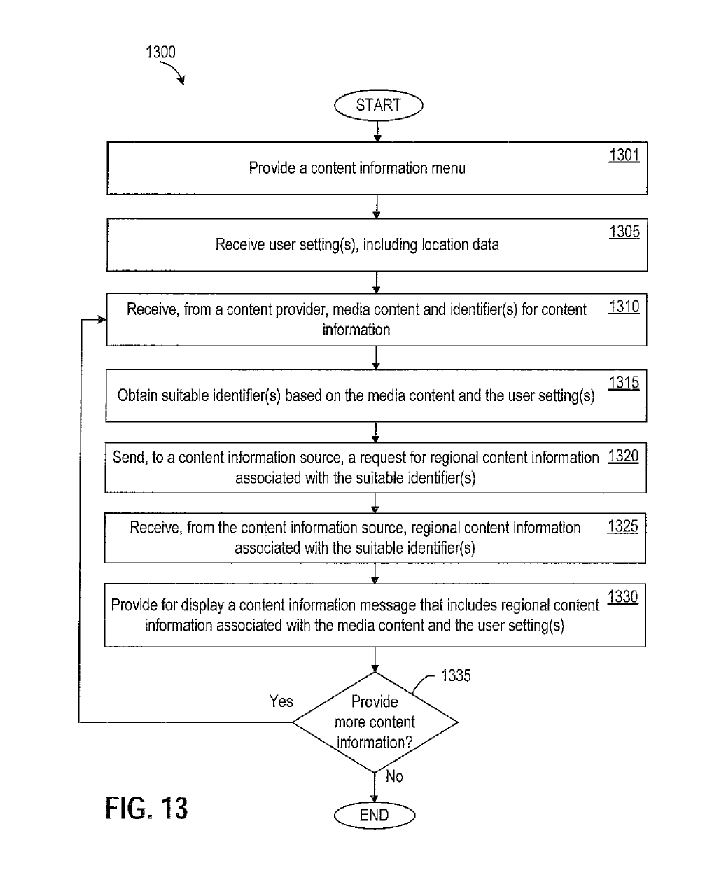

FIG. 13 is a flowchart of a method 1300 for providing regional content information to a user system, wherein a database system is a source of content information, in accordance with some embodiments. In some implementations, the steps of the method 1300 may be carried out by the content information device 415 of FIG. 4 or by the content information device 515 of FIG. 5. In an implementation, the method 1300 of FIG. 13 operates offline from content information source and not during a real-time communication with a content information source over the Internet. In an alternative implementation, the method 1300 operates during a real-time communication with a content information source over the Internet.

The method 1300 starts in a step 1301 where the system provides a content information menu. For example, the system may provide one or more content information menus that are configured for allowing a user to input user settings with respect to how the user would like to receive content information. Examples of content information menus are described above with reference to FIG. 7 through FIG. 9. Next, in a step 1305, the system receives one or more user settings, including location data. For example, the location data may be set automatically or manually, as described above with reference to FIG. 7 through FIG. 9.

The method 1300 moves to a step 1310 where the system receives, from a content provider, media content along with identifiers for content information. For example, a user device (e.g., television, laptop, etc.) may receive a television program from a content provider (e.g., cable television provider, satellite television provider, etc.), as described above with reference to FIG. 3. The media content may be interweaved and/or embedded with identifiers for content information, as described above with reference to FIG. 12.

The method 1300 proceeds to a step 1315 where the system obtains one or more suitable identifiers based on the media content and the one or more user settings. For example, a user system may select identifiers by searching the basic identifying information for identifying information associated with the one or more user settings, as discussed above with reference to FIG. 12. In another example, a user system may recognize the audio portion of media content and then dynamically generate a fingerprint for that audio portion, as discussed above with reference to FIG. 12.

Next, in a step 1320, the system sends, to a content information source, a request for content information associated with the suitable identifiers. For example, a user device may send a request, to a remote content information source and/or to a local content information source, for content information associated with suitable identifiers, as described above with reference to FIG. 3. The method 1300 then proceeds to a step 1325 where the system receives regional content information associated with the suitable identifiers. For example, a user device may receive content information from a content information source, as described above with reference to FIG. 12.

The method 300 then moves to a step 1330 where the system provides for display a content information message that includes content information associated with the media content and the user settings. For example, a user device may send a pop-up message to a display where the associated media content is being displayed, as described above with reference to FIG. 1 and FIG. 2.

In a decision operation 1335, the system determines if more content information is to be provided. If more content information is to be provided, then the method 1300 returns to the step 1310 where the system receives more media content and more identifiers for content information. However, if no more content information is to be provided, then the method 1300 concludes after the decision operation 1330.

Note that this method 1300 may include other details and steps that are not described in this method overview. Other details and steps are described above with reference to the appropriate figures and may be a part of the method 1300, depending on the embodiment.

### Content Information Source Performing Important Processing

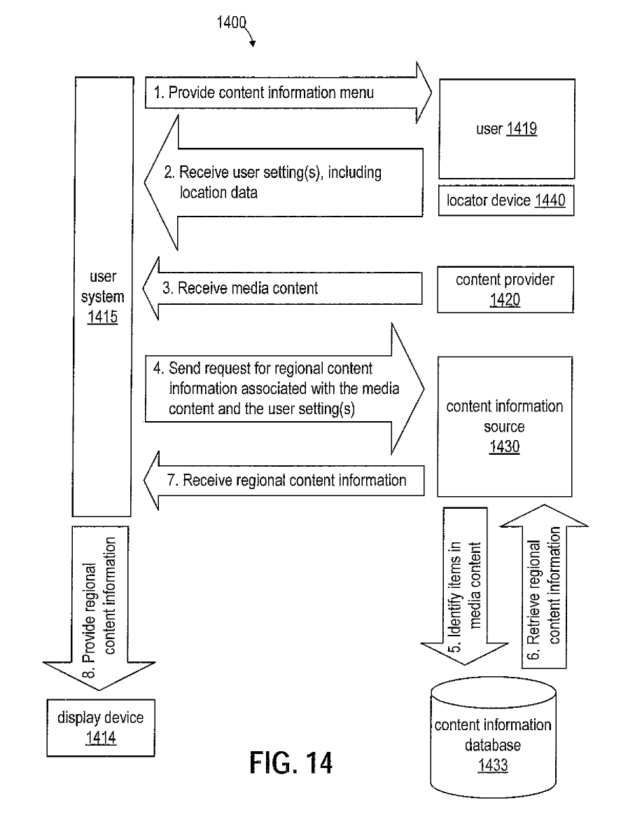

FIG. 14 is a diagram of a system 1400 configured for providing regional content information to a user system 1415, wherein a content information source performs important processing, in accordance with some embodiments. It will be readily appreciated that the diagram of FIG. 14 is for explanatory purposes, and that numerous variations are possible.

The user system 1215 is configured for providing a content information menu, as in the user system 1015 of FIG. 10. The user system is also configured for receiving one or more user settings, including location data, as in the system 1015 of FIG. 10.

In FIG. 14, the user system 1415 is configured for receiving media content from a content provider 1420. The media content may include, for example, a television program, an Internet video and/or a content media stream. The content provider 1420 may include a number of different sources (e.g., cable television provider, satellite television provider, television broadcaster, streaming content provider, etc.), as described above with reference to FIG. 3.

The user system 1415 is configured for sending, to a content information source 1430, a request for content information associated with the media content and the one or more user settings. The content information source 1430 is configured for receiving such a request for content information. The content information source 1430 may be either remote or local, as described above with reference to FIG. 3.

The content information source is configured for identifying, in the media content, items (e.g., video objects and/or audio cues) that may be associated with content information in a content information database 1433. For example, a server of the content information source 1430 may use video processing and/or audio processing techniques that allow recognition of video objects and/or audio cues in the media content. In another example, the media content may come from the content provider 1420 prepackaged with basic identifying information, such as, for example, movie title, producer names, production date, actor names, etc.

The content information source 1430 is configured for retrieving appropriate content information from a content information database 1433. For example, the content information source 1430 may match the identified video objects and/or audio cues to identifiers in the content information database 1433. U.S. patent application Ser. No. 16/716,269, which is described above with reference to FIG. 3, provides an example of a method for navigating and searching for content information on a database. The content information database 1433 is configured for pre-storing content information that is associated with media content, and is a part of the content information source 1430, as described above with reference to FIG. 3. The content information source 1430 is configured for sending the retrieved content information to the user system 1415.

The user system 1415 is configured for receiving the requested content information from the content information source 1430 and providing the content information for display on a display device 1413. It is important to note again that the content information is regional content information that is intended to be culturally relevant to the location that is set forth in the user settings, which are described above with reference to FIG. 7 though FIG. 9. The content information may be displayed in a content information message (e.g., pop-up message), as described above with reference to FIG. 1 and FIG. 2.

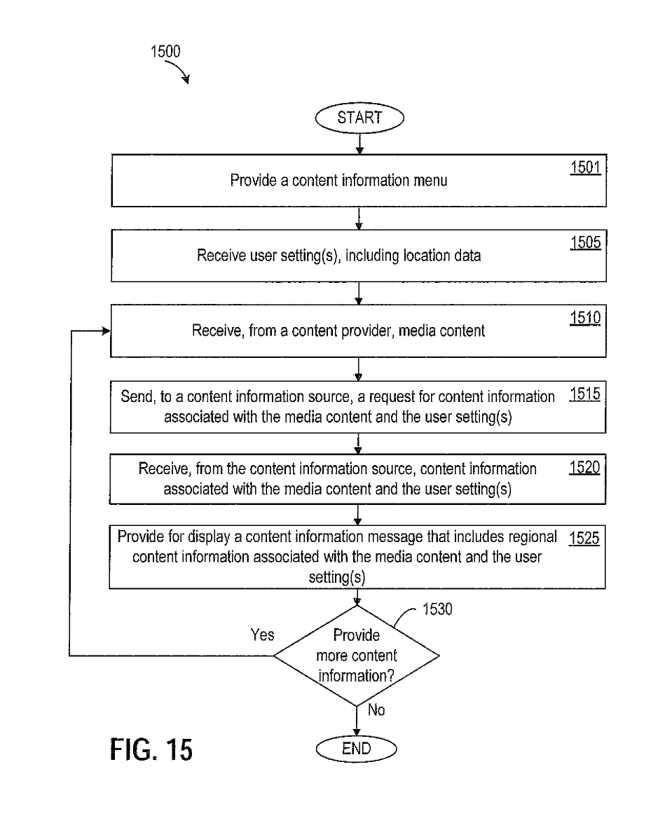

FIG. 15 is a flowchart of a method 1500 for providing regional content information to a user system, wherein a content information source performs important processing, in accordance with some embodiments. In some implementations, the steps of the method 1500 may be carried out by the content information device 415 of FIG. 4 or by the content information device 515 of FIG. 5. In an implementation, the method 1500 of FIG. 15 operates offline from content information source and not during a real-time communication with a content information source over the Internet. In an alternative implementation, the method 1500 operates during a real-time communication with a content information source over the Internet.

The method 1500 starts in a step 1501 where the system provides a content information menu. For example, the system may provide one or more content information menus that are configured for allowing a user to input user settings with respect to how the user would like to receive content information. Examples of content information menus are described above with reference to FIG. 7 through FIG. 9. Next, in a step 1505, the system receives one or more user settings, including location data. For example, the location data may be set automatically or manually, as described above with reference to FIG. 7 through FIG. 9.

The method 1500 then moves to a step 1510 where the system receives, from a content provider, media content. For example, a user device (e.g., television, laptop, etc.) may receive a television program from a content provider (e.g., cable television provider, satellite television provider, etc.), as described above with reference to FIG. 3.

Next, in a step 1515, the system sends, to a content information source, a request for content information associated with the media contents and the one or more user settings. For example, a user device may send a request, to a remote content information source or to a local content information source, for content information associated with the media content and the one or more user settings, as described above with reference to FIG. 3. The method 1500 then proceeds to a step 1520 where the system receives content information associated with the media content and the one or more user settings. For example, a user device may receive content information from a content information source, as described above with reference to FIG. 3.

The method 1500 then moves to a step 1525 where the system provides for display a content information message that includes content information associated with the media content and the user settings. For example, a user device may send a pop-up message to a display where the associated media content is being displayed, as described above with reference to FIG. 1 and FIG. 2.

In a decision operation 1530, the system determines if more content information is to be provided. If more content information is to be provided, then the method 1500 returns to the step 1510 where the system receives more media content. However, if no more content information is to be provided, then the method 1500 concludes after the decision operation 1530.

Note that this method 1500 may include other details and steps that are not described in this method overview. Other details and steps are described above with reference to the appropriate figures and may be a part of the method 1500, depending on the embodiment.

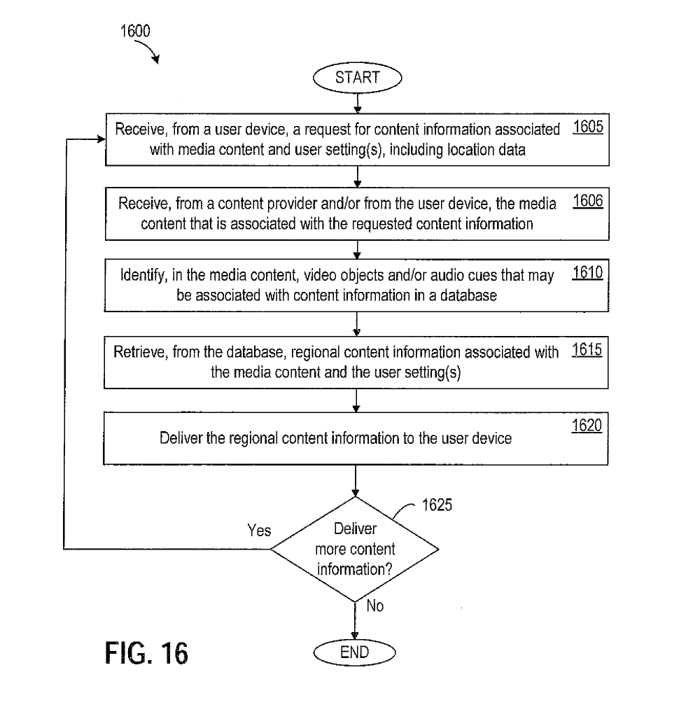

FIG. 16 is a flowchart of a method 1600 for delivering regional content information to a user system from a content information source, in accordance with some embodiments. In some implementations, the steps of the method 1600 may be carried out by a content information source of FIG. 3, a content information source of FIG. 4 or a content information source of FIG. 5.

The method starts in a step 1605 where the system receives, from a user device, a request for content information associated with media content and one or more user settings, including location data. For example, a content information source, which may be local or remote, may receive a request from a user device (e.g., television, laptop, etc.) for content information that is associated with media content and user settings, as described above with reference to FIG. 3. The user settings may include location data for the user device and other user settings, as described above with reference to FIG. 7 through FIG. 9.

The method 1600 moves to a step 1606 where the system receives, from a content provider and/or from the user device, the media content that is associated with the requested content information. For example, a content information source may receive a television program from a content provider (e.g., cable television provider, satellite television provider, etc.), as described above with reference to FIG. 3. In another example, the content information source may receive the television program from the user device, so that the content information source confidently receives media content that is also received at the user device.

The method then moves to a step 1610 where the system identifies, in the media content, items (e.g., video objects and/or audio cues) that may be associated with content information in a database. For example, a server of the content information source may use video processing and/or audio processing techniques that allow recognition of video objects and/or audio cues in media content.

The method 1600 then proceeds to a step 1615 where the system retrieves, from the database, content information associated with the media content and the one or more user settings. For example, a server of the content information source may retrieve appropriate content information from a content information database, as described above with reference to FIG. 3. Next, in a step 1620, the system delivers the appropriate content information for the user device. For example, a content information source may deliver content information to a user device (e.g., television, laptop, etc.), as described above with reference to FIG. 3.

In a decision operation 1625, the system determines if more content information is to be delivered. If more content information is to be delivered, then the method 1600 returns to the step 1605 where the system receives another request, from a user device, for content information. However, if no more content information is to be delivered, then the method 1600 concludes after the decision operation 1625.

Note that this method 1600 may include other details and steps that are not described in this method overview. Other details and steps are described above with reference to the appropriate figures and may be a part of the method 1600, depending on the embodiment.
IV.

### Computer Readable Medium Implementation

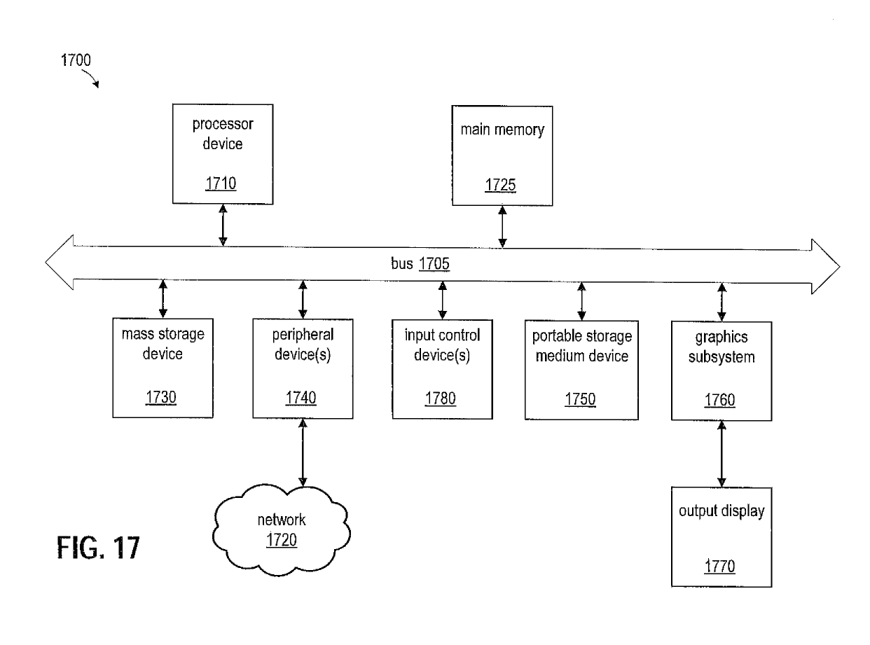

FIG. 17 is a block diagram of a general and/or special purpose computer 1700, in accordance with some embodiments. The computer 1700 may be, for example, a user device, a user computer, a client computer and/or a server computer, among other things. Examples of a user device include without limitation a Blu-ray Disc player, a personal media device, a portable media player, an iPod™, a Zune™ Player, a laptop computer, a palmtop computer, a smart phone, a cell phone, a mobile phone, an mp3 player, a digital audio recorder, a digital video recorder, a CD player, a DVD player, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

The computer 1700 preferably includes without limitation a processor device 1710, a main memory 1725, and an interconnect bus 1705. The processor device 1710 may include without limitation a single microprocessor, or may include without limitation a plurality of microprocessors for configuring the computer 1700 as a multi-processor system. The main memory 1725 stores, among other things, instructions and/or data for execution by the processor device 1710. If the system is partially implemented in software, the main memory 1725 stores the executable code when in operation. The main memory 1725 may include banks of dynamic random access memory (DRAM), as well as cache memory.

The computer 1700 may further include a mass storage device 1730, peripheral device(s) 1740, portable storage medium device(s) 1750, input control device(s) 1780, a graphics subsystem 1760, and/or an output display 1770. For explanatory purposes, all components in the computer 1700 are shown in FIG. 17 as being coupled via the bus 1705. However, the computer 1700 is not so limited. Devices of the computer 1700 may be coupled through one or more data transport means. For example, the processor device 1710 and/or the main memory 1725 may be coupled via a local microprocessor bus. The mass storage device 1730, peripheral device(s) 1740, portable storage medium device(s) 1750, and/or graphics subsystem 1760 may be coupled via one or more input/output (input/output) buses. The mass storage device 1740 is preferably a nonvolatile storage device for storing data and/or instructions for use by the processor device 1710. The mass storage device 1730, which may be implemented, for example, with a magnetic disk drive or an optical disk drive. In a software embodiment, the mass storage device 1730 is preferably configured for loading contents of the mass storage device 1730 into the main memory 1725.

The portable storage medium device 1750 operates in conjunction with a nonvolatile portable storage medium, such as, for example, a compact disc read only memory (CD ROM), to input and output data and code to and from the computer 1700. In some embodiments, the software for generating a synthetic table of contents is stored on a portable storage medium, and is inputted into the computer 1700 via the portable storage medium device 1750. The peripheral device(s) 1740 may include any type of computer support device, such as, for example, an input/output (input/output) interface configured to add additional functionality to the computer 1700. For example, the peripheral device(s) 1740 may include a network interface card for interfacing the computer 1700 with a network 1720.

The input control device(s) 1780 provide a portion of the user interface for a user of the computer 1700. The input control device(s) 1780 may include a keypad and/or a cursor control device. The keypad may be configured for inputting alphanumeric and/or other key information. The cursor control device may include, for example, a mouse, a trackball, a stylus, and/or cursor direction keys. In order to display textual and graphical information, the computer 1700 preferably includes the graphics subsystem 1760 and the output display 1770. The output display 1770 may include a cathode ray tube (CRT) display and/or a liquid crystal display (LCD). The graphics subsystem 1760 receives textual and graphical information, and processes the information for output to the output display 1770.

Each component of the computer 1700 may represent a broad category of a computer component of a general and/or special purpose computer. Components of the computer 1700 are not limited to the specific implementations provided here.

Portions of the invention may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure. Some embodiments are implemented by the preparation of application-specific integrated circuits and/or by coupling an appropriate network of conventional component circuits.

Some embodiments include a computer program product. The computer program product may be a storage medium and/or media having instructions stored thereon and/or therein which can be used to control, or cause, a computer to perform any of the processes of the invention. The storage medium may include without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of device suitable for storing instructions and/or data.

Stored on any one of the computer readable medium and/or media, some implementations include software for controlling both the hardware of the general and/or special computer or microprocessor, and for enabling the computer and/or microprocessor to interact with a human user and/or another mechanism utilizing the results of the invention. Such software may include without limitation device drivers, operating systems, and user applications. Ultimately, such computer readable media further includes software for performing aspects of the invention, as described above.

Included in the programming and/or software of the general and/or special purpose computer or microprocessor are software modules for implementing the processes described above. The processes described above may include without limitation the operations described with reference to FIG. 10 through FIG. 16.

### Advantages

The system of an embodiment provides regional content information to a user device (e.g., television laptop, cell phone, etc.). The system provides content information messages that provide explanations of cultural peculiarities that may occur in the original media content (e.g., television programs, Internet video, content media streams, etc.). Accordingly, the system allows media content to be understood by various users who have different cultural backgrounds.

The content information messages may be even more useful when sharing content among countries that share the same language but have different cultures (e.g., the United States, the United Kingdom, Australia and most of Canada). In such a case, the media content is often in English or another common language, and no translation is necessary. Because no translation takes place, such television programs do not get the localization benefits that oftentimes come with good language translations. The system fills this benefits gap.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for providing regional content information, wherein the method is carried out by at least one computer, the method comprising:
receiving one or more user settings that describe preferences for regional content information to be received at a user device, wherein the one or more user settings include at least location data for the user device;
receiving, from one or more content providers, media content and content information;
determining which content information to provide for display based on the media content and the one or more user settings; and
providing for display a content information message that includes regional content information associated with the media content and the one or more user settings, wherein the regional content information is culturally relevant to the location data that is included in the one or more user settings.

2. The method of claim 1, wherein the method is carried out by at least one of:
a user device;
a content information device;
a widget; and
a set-top box.

3. The method of claim 1, wherein the one or more user settings further include at least one of:
interests of a user;
age group of a user;
ethnicity of a user; and
gender of user.

4. The method of claim 1, wherein the location data is set by at least one of:
automatic input from a locator device; and
manual input that is received by way of a graphical user interface.

5. The method of claim 1, further comprising providing a content information menu, wherein the one or more user settings are set by receiving input via the content information menu, wherein the content information menu includes at least one of:
a graphical user interface;
a button;
a dialog box;
a pop-up window;
a pull-down menu;
an icon;
a scroll bar;
a resizable window edge;
progress indicator;
a selection box;
a window;
a tear-off menu;
a menu bar;
a toggle switch; and
a form.

6. The method of claim 1, wherein the media content includes at least one of:
video content;
audio content;
a television program;
a television broadcast;
a satellite transmission;
a cable transmission;
a network stream;
an Internet video; and
a content media stream.

7. The method of claim 1, wherein the one or more content providers include at least one of:
an entity configured for providing media content and content information to one or more user devices;
a cable television provider;
a satellite television provider;
a television broadcaster; and
a streaming content provider.

8. The method of claim 1, wherein the media content and the content information that is received from the one or more content providers is at least one of:
interweaved according to a standard for compression and transmission;
interweaved according to Moving Pictures Experts Group-2;
in accordance with Enhanced Television Binary Interchange Format; and
in synchronization with a time code.

9. The method of claim 1, wherein determining which content information to provide for display comprises identifying one or more items in the content information that are relevant to the user settings, wherein the one or more items include at least one of:
production information;
pop culture trivia;
a religion fact;
a history fact;
metadata; and
annotations.

10. The method of claim 1, wherein the content information message further includes ad space for an advertisement.

11. The method of claim 1, wherein the content information message is presented as at least one of:
a pop-up message; and
a message with a text scrolling feature.

12. A system for providing regional content information, wherein the system is configured for:
receiving one or more user settings that describe preferences for regional content information to be received at a user device, wherein the one or more user settings include at least location data for the user device;
receiving, from one or more content providers, media content and content information;
determining which content information to provide based on the media content and the one or more user settings; and
providing for display a content information message that includes regional content information associated with the media content and the one or more user settings, wherein the regional content information is culturally relevant to the location data that is included in the one or more user settings.

13. The system of claim 12, wherein the system includes at least one of:
a user device;
a content information device;
a widget; and
a set-top box.

14. The system of claim 12, wherein the one or more user settings further include at least one of:
interests of a user;
age group of a user;
ethnicity of a user; and
gender of user.

15. The system of claim 12, wherein the location data is set by at least one of:
automatic input from a locator device; and
manual input that is received by way of a graphical user interface.

16. The system of claim 12, wherein the system is further configured for providing a content information menu, wherein the one or more user settings are set by receiving input via the content information menu, and wherein the content information menu includes at least one of:
a graphical user interface;
a button;
a dialog box;
a pop-up window;
a pull-down menu;
an icon;
a scroll bar;
a resizable window edge;
progress indicator;
a selection box;
a window;
a tear-off menu;
a menu bar;
a toggle switch; and
a form.

17. The system of claim 12, wherein the media content includes at least one of:
video content;
audio content;
a television program;
a television broadcast;
a satellite transmission;
a cable transmission;
a network stream;
an Internet video; and
a content media stream.

18. The system of claim 12, wherein the one or more content providers include at least one of:
an entity configured for providing media content and content information to one or more user devices;
a cable television provider;
a satellite television provider;
a television broadcaster; and
a streaming content provider.

19. The system of claim 12, wherein the media content and the content information that is received from the one or more content providers is at least one of:
interweaved according to a standard for compression and transmission;
interweaved according to Moving Pictures Experts Group-2;
in accordance with Enhanced Television Binary Interchange Format; and
in synchronization with a time code.

20. The system of claim 12, wherein determining which content information to provide for display further configures the system for identifying one or more items in the content information that are relevant to the user settings, wherein the one or more items include at least one of:
production information;
pop culture trivia;
a religion fact;
a history fact;
metadata; and
annotations.

21. The system of claim 12, wherein the content information message further includes ad space for an advertisement.

22. The system of claim 12, wherein the content information message is presented as at least one of:
a pop-up message; and
a message with a text scrolling feature.

23. A computer readable medium comprising one or more instructions for providing regional content information, wherein the one or more instructions are configured for causing one or more processors to perform the steps of:
receiving one or more user settings that describe preferences for regional content information to be received at a user device, wherein the one or more user settings include at least location data for the user device;
receiving, from one or more content providers, media content and content information;
determining which content information to provide for display based on the media content and the one or more user settings; and
providing for display a content information message that includes regional content information associated with the media content and the one or more user settings, wherein the regional content information is culturally relevant to the location data that is included in the one or more user settings.
